(19) United States
(12) Patent Application Publication
(10) Pub. No.: US 2026/0124903 A1
(43) Pub. Date: May 7, 2026

(54) COOLING SYSTEM

(71) Applicant: AISIN CORPORATION, Kariya, Aichi (JP)

(72) Inventor: Sho HASEGAWA, Kariya-shi (JP)

(73) Assignee: AISIN CORPORATION, Kariya, Aichi (JP)

(21) Appl. No.: 19/118,079

(22) PCT Filed: Oct. 20, 2023
(86) PCT No.: PCT/JP2023/037987

§ 371 Date: Apr. 3, 2025

(30) Foreign Application Priority Data
Oct. 25, 2022 (JP) 2022-170857

(51) Int. Cl. B60K 11/02; B60K 1/00

(52) U.S. Cl. CPC B60K 11/02; B60K 2001/005; B60K 2001/006

(57) ABSTRACT

A cooling system includes a motor, a power converter, a flow path through which a cooling fluid flows to the motor and the power converter, and a switching valve that switches the flow path through which the cooling fluid flows. The flow path includes a first flow path and a second flow path that are bifurcated and rejoined, the motor is disposed in the first flow path, and the power converter is disposed in the second flow path. The switching valve is disposed at a position where the flow path branches into the first flow path and the second flow path, and is configured to be switchable the flow path through which the cooling fluid flows to the first flow path and the second flow path.

### TECHNICAL FIELD

The present disclosure relates to a cooling system.

### BACKGROUND ART

In recent years, automobiles including motors as traveling drive sources (hybrid electric vehicle (HEV), plug-in hybrid electric vehicle (PHEV), battery electric vehicle (BEV), fuel cell electric vehicle (FCEV), and the like) have been widely used. These automobiles (hereinafter, collectively referred to as “electric vehicles”) include a battery for driving a motor. The electric vehicle includes many devices that require cooling, such as a motor (including an internal combustion engine such as an engine), a battery, an air conditioner, and an ECU. For this reason, a cooling circuit that circulates cooling water or a refrigerant is configured to cool these devices. However, these devices may have different appropriate operating temperatures. In such a case, in order to change the temperature of the cooling water or the refrigerant to be circulated for each device having a different operating temperature, heat is transferred through a heat exchanger such as a chiller or a water-cooled condenser to control the temperature of the cooling water or the refrigerant.

The cooling circuit disclosed in Patent Literature 1 includes a plurality of control modes of controlling a first pump, a second pump, a first switching valve, and a second switching valve to change the flow of cooling water in a first cooling water flow path, a second cooling water flow path, a third cooling water flow path, a fourth cooling water flow path, and a bypass flow path depending on an outside air temperature or a battery water temperature. In the second cooling water flow path, an inverter cooling unit and a motor generator cooling unit are arranged in series in this order from the upstream side in the flow direction of the cooling water.

### CITATIONS LIST

### Patent Literature

Patent Literature 1: JP 2019-023059 A

### SUMMARY OF INVENTION

### Technical Problems

In the second cooling water flow path of the cooling circuit disclosed in Patent Literature 1, cooling water is heated by heat exchange with an inverter and a motor generator. In the cooling circuit, the inverter cooling unit is disposed on the upstream side in the flow direction of the cooling water in the second cooling water flow path, and the motor generator cooling unit is disposed on the downstream side. For this reason, the cooling water is first heated by absorbing heat of the inverter in the inverter cooling unit, and then heated by absorbing heat of the motor generator in the motor generator cooling unit. Therefore, the cooling water absorbs the heat of the motor generator after absorbing the heat of the inverter, and thus the absorption amount of heat of the motor generator in the motor generator cooling unit decreases.

The present disclosure has been made in view of the above problems, and the present disclosure provides a cooling system capable of efficiently absorbing heat generated by a cooling fluid in a motor.

### Solutions to Problems

One embodiment of a cooling system according to the present disclosure includes a motor, a power converter, a flow path through which a cooling fluid flows to the motor and the power converter, and a switching valve that switches the flow path through which the cooling fluid flows, the flow path includes a first flow path and a second flow path that are bifurcated and rejoined, the motor is disposed in the first flow path, the power converter is disposed in the second flow path, and the switching valve is disposed at a position where the flow path branches into the first flow path and the second flow path, and is configured to be switchable the flow path through which the cooling fluid flows to the first flow path and the second flow path.

In the cooling system of the present embodiment, the motor is disposed in the first flow path, the power converter is disposed in the second flow path, and the switching valve is disposed at the position where the flow path branches into the first flow path and the second flow path, and the switching valve is configured to be switchable the flow path through which the cooling fluid flows to the first flow path and the second flow path. As a result, the motor and the power converter are arranged in parallel with the flow path, so that the problem that the amount of heat absorbed by the cooling fluid in the motor decreases because the cooling fluid absorbs the heat of the power converter and then absorbs the heat of the motor does not occur. As a result, it is possible to provide the cooling system in which that the cooling fluid can efficiently absorb the heat generated in the motor.

### BRIEF DESCRIPTION OF DRAWINGS

FIG. 1 is a configuration diagram illustrating a control example of a cooling system according to the present embodiment.

FIG. 2 is a flowchart illustrating an operation of the cooling system.

FIG. 3 is a configuration diagram illustrating a control example of the cooling system according to the present embodiment.

FIG. 4 is a configuration diagram illustrating a control example of the cooling system according to the present embodiment.

FIG. 5 is a configuration diagram illustrating a control example of the cooling system according to the present embodiment.

### DESCRIPTION OF EMBODIMENTS

Hereinafter, embodiments of a cooling system according to the present disclosure will be described in detail with reference to the drawings. Note that the embodiments described below are examples for describing the present disclosure, and the present disclosure is not limited only to these embodiments. Therefore, the present disclosure can be implemented in various modes without departing from the gist thereof.

### Configuration of Cooling System

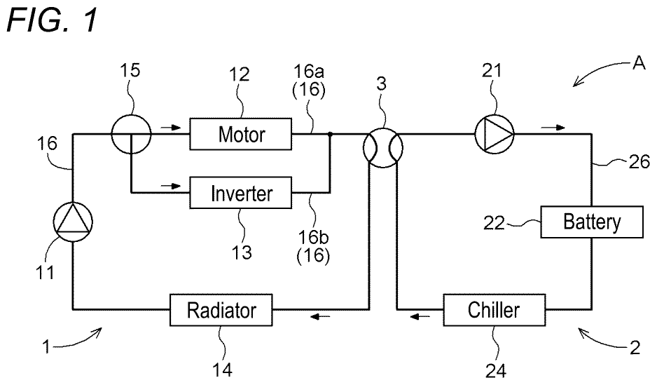

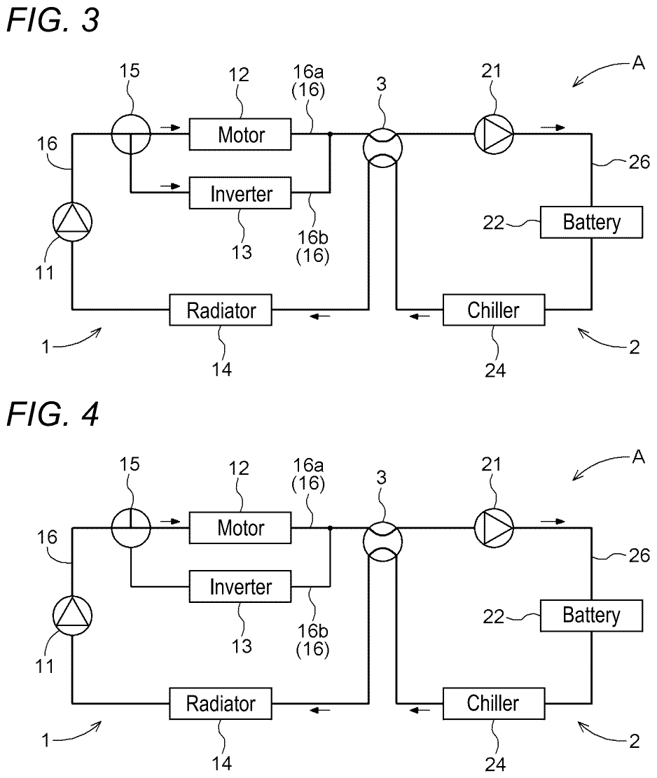

A cooling system A according to the present embodiment is used for automobiles including motors as traveling drive sources (hybrid electric vehicle (HEV), plug-in hybrid electric vehicle (PHEV), battery electric vehicle (BEV), fuel cell electric vehicle (FCEV), and the like). Hereinafter, these automobiles are collectively referred to as electric vehicles. As illustrated in FIG. 1, the cooling system A includes a motor cooling circuit 1 through which a cooling fluid flows, a battery cooling circuit 2, and a four-way valve 3. The four-way valve 3 switches between a connected state where the motor cooling circuit 1 and the battery cooling circuit 2 are connected and an independent state where the motor cooling circuit 1 and the battery cooling circuit 2 are disconnected. The four-way valve 3 illustrated in FIG. 1 represents the independent state where the motor cooling circuit 1 and the battery cooling circuit 2 are disconnected, and the four-way valve 3 illustrated in FIGS. 3 to 5 represents the connected state where the motor cooling circuit 1 and the battery cooling circuit 2 are connected.

The motor cooling circuit 1 includes a motor pump 11 including a water pump or the like that pumps a cooling fluid, a motor 12 that is a drive source of an electric vehicle, an inverter 13 (an example of power converter) that supplies power to the motor 12, a radiator 14 that cools the cooling fluid, a motor flow path 16 (an example of flow path) that causes the cooling fluid to flow therethrough, and a switching valve 15 that switches the motor flow path 16. Note that the cooling fluid is cooling water such as a long life coolant (LLC), insulating oil such as paraffin, or a refrigerant such as hydrofluorocarbon (HFC) or hydrofluoroolefin (HFO). In the present embodiment, it is preferable to use cooling water such as a long life coolant (LLC) or a liquid with high electrical insulation properties such as a fluorine-based inert liquid, and a cooling liquid containing cooling water or insulating oil may be used. Furthermore, the power converter also includes, for example, a DC-DC converter, an on board charger (OBC), and the like.

The motor flow path 16 includes a first motor flow path 16a (an example of first flow path) and a second motor flow path 16b (an example of second flow path) that are bifurcated and joined again. The motor 12 is cooled by the cooling fluid flowing through the first motor flow path 16a, and the inverter 13 is cooled by the cooling fluid flowing through the second motor flow path 16b. The switching valve 15 is disposed at a position where the motor flow path 16 is branched into the first motor flow path 16a and the second motor flow path 16b. By switching a valve body, the switching valve 15 is switchable in four ways, that is, a case where the cooling fluid flows only through the first motor flow path 16a, a case where the cooling fluid flows only through the second motor flow path 16b, a case where the cooling fluid flows through both the first motor flow path 16a and the second motor flow path 16b, and a case where the cooling fluid does not flow through the first motor flow path 16a and the second motor flow path 16b. Note that the switching valve 15 may be switchable in three ways except for the case where the cooling fluid does not flow through the first motor flow path 16a and the second motor flow path 16b.

Next, an operation of the motor cooling circuit 1 in a case where the motor cooling circuit 1 and the battery cooling circuit 2 are in the independent state by the four-way valve 3 will be described. The independent state can be implemented by rotating the valve body 90 degrees from the state of the four-way valve 3 illustrated in FIG. 3 to the state of FIG. 1. The cooling fluid pumped from the motor pump 11 flows through the motor flow path 16 into the switching valve 15. Since the motor pump 11 is in operation, the switching valve 15 is switched to one of the case of allowing the cooling fluid to flow only through the first motor flow path 16a, the case of allowing the cooling fluid to flow only through the second motor flow path 16b, and the case of allowing the cooling fluid to flow through both the first motor flow path 16a and the second motor flow path 16b. The switching valve 15 illustrated in FIG. 1 represents a state where the cooling fluid flows through both the first motor flow path 16a and the second motor flow path 16b.

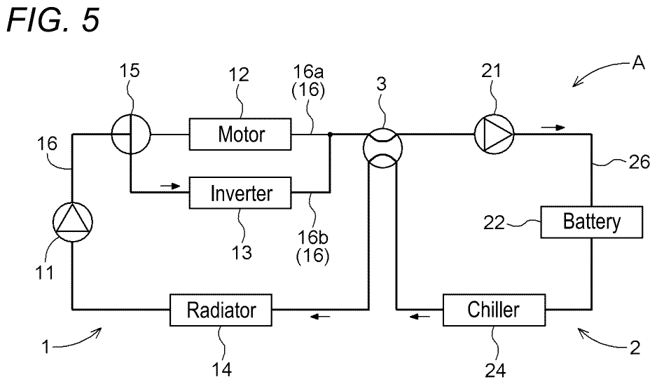

In a case where the switching valve 15 is switched so as to allow the cooling fluid to flow only through the first motor flow path 16a, the cooling fluid flowing into the switching valve 15 flows only through the first motor flow path 16a, and is heated by absorbing heat generated in the motor 12 (see FIG. 4). In a case where the switching valve 15 is switched so as to allow the cooling fluid to flow only through the second motor flow path 16b, the cooling fluid flowing into the switching valve 15 flows only through second motor flow path 16b, and is heated by absorbing heat generated in the inverter 13 (see FIG. 5). In a case where the switching valve 15 is switched so as to allow the cooling fluid to flow through both the first motor flow path 16a and the second motor flow path 16b, the cooling fluid flowing into the switching valve 15 flows through both the first motor flow path 16a and the second motor flow path 16b, and is heated by absorbing heat generated in the motor 12 and the inverter 13 (see FIGS. 1 and 3). In either case, the cooling fluid with increased temperature by heating flows through the motor flow path 16 into the radiator 14, is cooled by the radiator 14, and returns to the motor pump 11.

Next, the battery cooling circuit 2 will be described. The battery cooling circuit 2 includes a battery pump 21 including a water pump or the like that pumps a cooling fluid, a battery 22 that supplies power to the inverter 13, a chiller 24 that cools the cooling fluid, and a battery flow path 26 (an example of flow path) that causes the cooling fluid to flow therethrough. The battery flow path 26 of the battery cooling circuit 2 is switchable between the connected state and the independent state with respect to the motor flow path 16 of the motor cooling circuit 1 by switching the four-way valve 3.

Next, an operation of the battery cooling circuit 2 in a case where the motor cooling circuit 1 and the battery cooling circuit 2 are in the independent state by the four-way valve 3 will be described. The cooling fluid pumped from the battery pump 21 flows through the battery flow path 26 into the battery 22. The cooling fluid is heated by absorbing heat generated in the battery 22. The cooling fluid with increased temperature by heating flows through the battery flow path 26 into the chiller 24, is cooled by the chiller 24, and returns to the battery pump 21.

### Operation of Cooling System

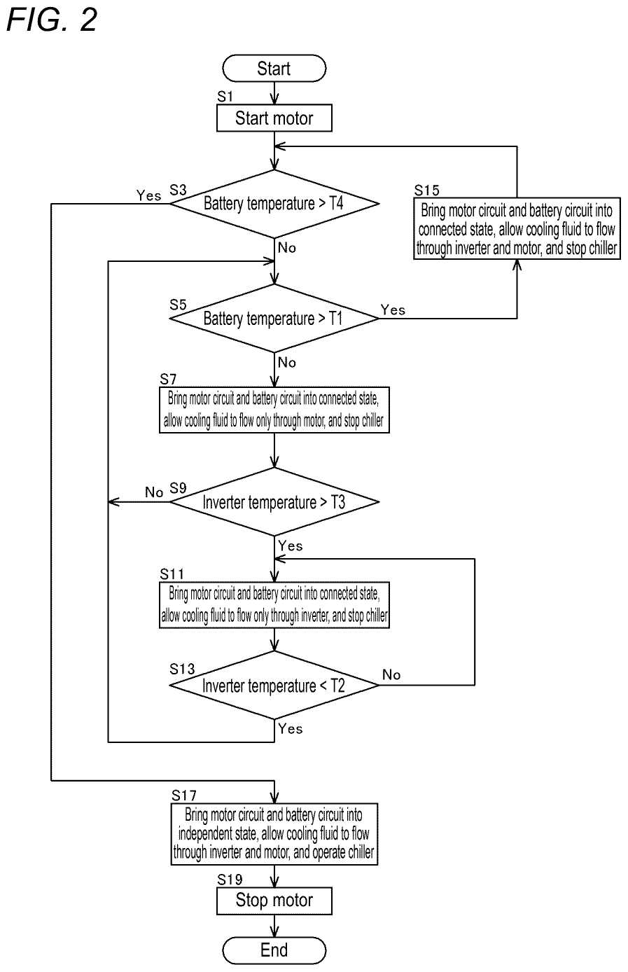

Next, an operation of the cooling system A will be described with reference to FIG. 2. In the present embodiment, temperatures T1 (first temperature) to T4 (fourth temperature) illustrated in FIG. 2 are set so as to satisfy T1<T2<T4<T3. In the following description, operations of the motor pump 11, the motor 12, the inverter 13, the radiator 14, the switching valve 15, the battery pump 21, the battery 22, and the chiller 24 are controlled by an electronic control unit (ECU) (not illustrated). The temperatures of the motor 12, the inverter 13, and the battery 22 are measured by a temperature sensor (not illustrated), and the measurement results are input to the ECU. Note that the temperatures of the motor 12, the inverter 13, and the battery 22 may be estimated from the temperatures of the cooling fluid flowing therethrough.

When a power switch of a stopped electric vehicle is pressed to start the motor 12 (step S1), the temperature sensor measures the temperature of the battery 22. If the temperature of the battery 22 exceeds a fourth temperature T4 (for example, 35 degrees) (Yes in step S3), the four-way valve 3 is switched so as to bring the motor cooling circuit 1 and the battery cooling circuit 2 into the independent state. The switching valve 15 is then switched so as to allow the cooling fluid to flow through both the first motor flow path 16a and the second motor flow path 16b, and the chiller 24 operates (step S17 and see FIG. 1). The temperatures of the motor 12 and the inverter 13 immediately after start-up are substantially the same as the temperature of the battery 22. If the temperature of the battery 22 exceeds the fourth temperature T4, the motor 12, the inverter 13, and the battery 22 need to be cooled, and the motor cooling circuit 1 and the battery cooling circuit 2 are switched to the independent state so as to cool these components to the maximum. That is, in the motor cooling circuit 1, the cooling fluid flows through both the first motor flow path 16a and the second motor flow path 16b, and is heated by cooling the motor 12 and the inverter 13, and then cooled by the radiator 14. In the battery cooling circuit 2, the cooling fluid is heated by cooling the battery 22, and then is cooled by the chiller 24. The state of step S17 is continued until the power switch of the electric vehicle is pressed again and the motor 12 is stopped (step S19).

If the temperature of the battery 22 immediately after the start-up of the motor 12 is lower than or equal to the fourth temperature T4 (No in step S3) and exceeds a first temperature T1 (for example, 5 degrees, an example of first predetermined temperature) (Yes in step S5), the four-way valve 3 is switched so as to bring the motor cooling circuit 1 and the battery cooling circuit 2 into the connected state. The switching valve 15 is then maintained in a manner that the cooling fluid flows through both the first motor flow path 16a and the second motor flow path 16b, and the chiller 24 stops (step S15 and see FIG. 3). When the motor cooling circuit 1 and the battery cooling circuit 2 are in the connected state, the cooling fluid flowing through the motor flow path 16 after the first motor flow path 16a and the second motor flow path 16b are joined flows into the battery pump 21 disposed in the battery flow path 26 of the battery cooling circuit 2. The cooling fluid flowing through the battery flow path 26 on the downstream side of the chiller 24 flows into the radiator 14 of the motor cooling circuit 1. Note that “stopping the chiller 24” means that the cooling fluid is not cooled by the chiller 24, and is implemented, for example, by switching to a bypass flow path bypassing the chiller 24.

If the temperature of the battery 22 exceeds the first temperature T1 and is or lower than or equal to the fourth temperature T4, control is executed to warm up the battery 22 while cooling the motor 12 and the inverter 13. That is, in the motor cooling circuit 1, the cooling fluid flows through both the first motor flow path 16a and the second motor flow path 16b, and is heated by cooling the motor 12 and the inverter 13. The heated cooling fluid flows into the battery cooling circuit 2 and warms up the battery 22. The cooling fluid cooled by warming up the battery 22 is not further cooled by the chiller 24 but cooled only by the radiator 14. As described above, since the cooling fluid is not excessively cooled, the battery 22 can be warmed up while the motor 12 and the inverter 13 are cooled. The state of step S15 is continued until the battery 22 is warmed up to reach the fourth temperature T4. If the battery 22 exceeds the fourth temperature T4 (Yes in step S3), the motor cooling circuit 1 and the battery cooling circuit 2 are switched to the state in step S17.

If the temperature of the battery 22 immediately after the start-up of the motor 12 is lower than or equal to the first temperature T1 (No in step S5), the four-way valve 3 is switched so as to bring the motor cooling circuit 1 and the battery cooling circuit 2 into the connected state. The switching valve 15 is then switched so as to allow the cooling fluid to flow only through the first motor flow path 16a, and the chiller 24 is stopped (step S7 and see FIG. 4).

If the temperature of the battery 22 is lower than or equal to the first temperature T1, control is executed to warm up the battery 22 while cooling the motor 12. That is, in the motor cooling circuit 1, the cooling fluid flows only through the first motor flow path 16a, and is heated by cooling the motor 12. Since the cooling fluid is retained in the second motor flow path 16b, the inverter 13 heats by itself without being cooled. The cooling fluid heated by the motor 12 flows into the battery cooling circuit 2 and warms up the battery 22. The cooling fluid cooled by warming up the battery 22 is not further cooled by the chiller 24 but cooled only by the radiator 14. As a result, the cooling fluid is not excessively cooled, and thus the battery 22 can be warmed up while the motor 12 is cooled. In addition, since the cooling fluid is heated using the self-heating of the motor 12 with a large heat capacity, it is possible to quickly increase the temperature of the battery 22 to promote warm-up.

As described above, if the temperature of the battery 22 is lower than or equal to the first temperature T1, the cooling fluid does not flow through the inverter 13. As a result, when the motor 12 is continuously driven, the temperature of the inverter 13 increases. If the temperature of the inverter 13 is lower than or equal to the third temperature T3 (for example, 40 degrees, an example of third predetermined temperature) (No in step S9), the process returns to step S5, and the temperature sensor measures the temperature of the battery 22. As long as the temperature of the battery 22 is lower than or equal to the first temperature T1 and the temperature of the inverter 13 is lower than or equal to the third temperature T3, the state of step S7 is continued.

If the temperature of the inverter 13 exceeds the third temperature T3 (Yes in step S9), the switching valve 15 is switched so as to allow the cooling fluid to flow only through the second motor flow path 16b (step S11 and see FIG. 5). That is, the cooling fluid in the first motor flow path 16a is retained. At this time, the motor cooling circuit 1 and the battery cooling circuit 2 are in the connected state, and the chiller 24 is stopped.

The inverter 13 is cooled by the cooling fluid flowing through the inverter 13, and the temperature of the inverter 13 decreases to the third temperature T3 or lower.

The state of step S11 is continued until the temperature of the inverter 13 becomes lower than the second temperature T2 (for example, 30 degrees and an example of second predetermined temperature) (No in step S13). When the temperature of the inverter 13 becomes lower than the second temperature T2 (Yes in step S13), the process returns to step S5, and the temperature of the battery 22 is measured. If the temperature of the battery 22 is still lower than or equal to the first temperature T1 (No in step S5), as illustrated in FIG. 4, the switching valve 15 is switched again so as to allow the cooling fluid to flow only through the first motor flow path 16a, and step S7 is performed. The above series of steps is repeated until the temperature of the battery 22 exceeds the first temperature T1. If the battery 22 exceeds the first temperature T1 (Yes in step S5), the motor cooling circuit 1 and the battery cooling circuit 2 are switched to the state in step S15 as illustrated in FIG. 3.

As described above, in the cooling system A according to the present embodiment, the motor 12 is disposed in the first motor flow path 16a, the inverter 13 is disposed in the second motor flow path 16b, the switching valve 15 is disposed at a position where the motor flow path 16 branches into the first motor flow path 16a and the second motor flow path 16b, and the motor flow path 16 through which the cooling fluid flows can be switched to the first motor flow path 16a and the second motor flow path 16b by the switching valve 15. As a result, the motor 12 and the inverter 13 are arranged in parallel with the motor flow path 16, so that the problem that the amount of heat absorbed by the cooling fluid in the motor 12 decreases because the cooling fluid absorbs the heat of the inverter 13 and then absorbs the heat of the motor 12 does not occur. In addition, when the battery 22 is warmed up, the cooling fluid flows only through the first motor flow path 16a, so that the cooling fluid is heated using self-heating of the motor 12 with a large heat capacity, and the temperature of the battery 22 can be quickly increased.

Moreover, the switching valve 15 of the cooling system A switches the motor flow path 16 through which the cooling fluid flows to the first motor flow path 16a and the second motor flow path 16b on the basis of the fact that the temperature of the battery 22 is lower than or equal to the first temperature T1 (for example, 5 degrees) and the fact that the temperature of the inverter 13 exceeds the third temperature T3 (for example, 40 degrees), so that the cooling fluid can efficiently absorb heat generated in the motor 12 while appropriately controlling the temperatures of the battery 22 and the inverter 13. In particular, in a case where a CPU is built in the inverter 13, the CPU is weak against heat, and thus it is important to appropriately control the temperature of the inverter 13.

Furthermore, in the cooling system A, when the temperature of the battery 22 is lower than or equal to the first temperature T1 (for example, 5 degrees) and the temperature of the inverter 13 is lower than the second temperature T2 (for example, 30 degrees), it is necessary to warm up the battery 22. Therefore, by switching the switching valve 15 so as to allow the cooling fluid to flow only through the first motor flow path 16a, it is possible to efficiently warm up the battery 22 while heating the cooling water by efficiently absorbing the heat of the motor 12 with a large heat capacity. In this state, the cooling fluid does not flow through the second motor flow path 16b, and thus the inverter 13 heats by itself without being cooled. Since there is a risk of failure of the inverter 13 when the inverter reaches a high temperature, when the temperature of the inverter 13 exceeds the third temperature T3 (for example, 40 degrees), the switching valve 15 is switched so as to allow the cooling fluid to flow only through the second motor flow path 16b. This makes it possible to efficiently warm up the battery 22 while preventing the failure of the inverter 13.

Furthermore, when the temperature of the battery 22 exceeds the first temperature T1 (for example, 5 degrees), the switching valve 15 of the cooling system A is switched so as to allow the cooling fluid to flow through both the first motor flow path 16a and the second motor flow path 16b, so that the cooling of the motor 12 and the inverter 13 can be prioritized over the warm-up of the battery 22.

### Other Embodiments

(1) In the above embodiment, the switching valve 15 is controlled on the basis of the temperature of the inverter 13, but the switching valve 15 may be controlled on the basis of the temperature of the motor 12.
(2) In the above embodiment, the chiller 24 is stopped in order to prioritize the warm-up of the battery 22. However, the chiller 24 may be operated in a case where it is necessary for the chiller 24 to exchange heat in a refrigerant circuit (for example, a heat pump system) in which heat exchange with the chiller 24 is performed.
(3) The control of switching the motor 12 and the inverter 13 configured by the parallel flow paths (the first motor flow path 16a and the second motor flow path 16b) using the switching valve 15 as in the above embodiment is not limited to the above embodiment. For example, in a case where the temperature of the battery 22 is lower than or equal to the first temperature T1 (for example, 5 degrees), the switching valve 15 may be switched so as to allow the cooling fluid to flow only through the second motor flow path 16b, and the battery 22 may be warmed up using self-heating of the inverter 13.

In the above embodiment, the following configuration is conceived.

<1> One mode of a cooling system (A) includes a motor (12), a power converter (13), a flow path (16, 16a, 16b) through which a cooling fluid flows to the motor (12) and the power converter (13), and a switching valve (15) that switches the flow path (16a, 16b) through which the cooling fluid flows, the flow path includes a first flow path (16a) and a second flow path (16b) that are bifurcated and rejoined, the motor (12) is disposed in the first flow path (16a), the power converter (13) is disposed in the second flow path (16b), and the switching valve (15) is disposed at a position where the flow path (16) branches into the first flow path (16a) and the second flow path (16b), and, the switching valve is configured to be switchable the flow path through which the cooling fluid flows to the first flow path (16a) and the second flow path (16b).

In the present aspect, the motor (12) is disposed in the first flow path (16a), the power converter (13) is disposed in the second flow path (16b), the switching valve (15) is disposed at the position where the flow path (16) branches into the first flow path (16a) and the second flow path (16b), and the switching valve (15) is configured to be switchable the flow path (16) through which the cooling fluid flows to the first flow path (16a) and the second flow path (16b). As a result, the motor (12) and the power converter (13) are arranged in parallel with the flow path (16a, 16b), and the problem that the amount of heat absorbed by the cooling fluid in the motor (12) decreases because the cooling fluid absorbs the heat of the power converter (13) and then absorbs the heat of the motor (12) does not occur. As a result, it is possible to provide the cooling system (A) in which that the cooling fluid can efficiently absorb heat generated in the motor (12).

<2> Preferably, the cooling system (A) of <1> further includes a battery (22) used to drive the motor (12), and the switching valve (15) switches the flow path through which the cooling fluid flows to the first flow path (16a) and the second flow path (16b) based on the temperature of the battery (22).

According to this, the cooling system (A) further includes the battery (22) used to drive the motor. The switching valve (15) switches the flow path through which the cooling fluid flows to the first flow path (16a) and the second flow path (16b) based on the temperature of the battery (22), so that the cooling fluid can efficiently absorb the heat generated in the motor (12) while appropriately controlling the temperature of the battery (22). In addition, when the battery (22) is warmed up, the cooling fluid flows only through the first flow path (16a), so that the cooling fluid can be heated using self-heating of the motor (12) with a large heat capacity, and the temperature of the battery (22) can be quickly increased.

<3> Preferably, the cooling system (A) of <2> includes a battery flow path (26) connectable to the flow path (16) in which the first flow path (16a) and the second flow path (16b) are joined, and the battery (22) is connected to the battery flow path (26).

According to this, the cooling system (A) includes the battery flow path (26) connectable to the flow path (16) in which the first flow path (16a) and the second flow path (16b) are joined, and the battery (22) is connected to the battery flow path (26).

As a result, the cooling fluid flows only through the first flow path (16a) to heat the cooling fluid using the self-heating of the motor (12) with a large heat capacity, and the cooling fluid flows from the flow path (16) to the battery flow path (26), so that the temperature of the battery (22) can be quickly increased.

<4> In the cooling system (A) of <3>, the switching valve (15) preferably switches the flow path through which the cooling fluid flows to the first flow path (16a) and the second flow path (16b) based on the temperature of the power converter (13).

According to this, since the switching valve (15) switches the flow path through which the cooling fluid flows to the first flow path (16a) and the second flow path (16b) based on the temperature of the power converter (13), the cooling fluid can efficiently absorb the heat generated in the motor (12) while appropriately controlling the temperature of the power converter (13). In particular, in a case where a CPU is built in the power converter (13), the CPU is weak against heat, and thus it is important to appropriately control the temperature of the power converter (13).

<5> In the cooling system (A) of <4>, preferably, the switching valve (15) is switched so as to allow the cooling fluid to flow only through the first flow path (16a) when the temperature of the battery (22) is lower than or equal to a first predetermined temperature (T1) and the temperature of the power converter (13) is lower than a second predetermined temperature (T2), and the switching valve is switched so as to allow the cooling fluid to flow only through the second flow path (16b) when the temperature of the battery (22) is lower or equal to than the first predetermined temperature (T1) and the temperature of the power converter (13) exceeds a third predetermined temperature (T3) higher than the second predetermined temperature (T2).

According to this, when the temperature of the battery (22) is lower than or equal to the first predetermined temperature (T1) and the temperature of the power converter (13) is lower than the second predetermined temperature (T2), the battery (22) needs to be warmed up, so that the switching valve (15) is switched so as to allow the cooling fluid to flow only through the first flow path (16a). As a result, it is possible to efficiently warm up the battery (22) while heating the cooling fluid by efficiently absorbing the heat of the motor (12). Furthermore, in this state, the cooling fluid does not flow through the second flow path (16b), and thus the power converter (13) heats by itself without being cooled. Since there is a risk of failure of the power converter (13) when the power converter reaches a high temperature by heating, when the temperature of the power converter (13) exceeds a third predetermined temperature (T3) higher than the second predetermined temperature (T2), the switching valve (15) is switched so as to allow the cooling fluid to flow only through the second flow path (16b). As a result, it is possible to efficiently warm up the battery (22) while preventing the failure of the power converter (13).

<6> In the cooling system (A) of <4>, the switching valve (15) is preferably switched so as to allow the cooling fluid to flow through both the first flow path (16a) and the second flow path (16b) when the temperature of the battery (22) exceeds the first predetermined temperature (T1).

According to this, when the temperature of the battery (22) exceeds the first predetermined temperature (T1), the switching valve (15) is switched so as to allow the cooling fluid to flow through both the first flow path (16a) and the second flow path (16b), so that the cooling of the motor (12) and the power converter (13) can be prioritized over the warm-up of the battery (22).

### INDUSTRIAL APPLICABILITY

The present disclosure can be used for a cooling system.

### REFERENCE SIGNS LIST

12: Motor, 13: Inverter (Power converter), 15: Switching valve, 16: Motor flow path (Flow path), 16a: First motor flow path (First flow path, Flow path), 16b: Second motor flow path (Second flow path, Flow path), 22: Battery, 26: Battery flow path (Flow path), A: Cooling system, T1: First temperature (First predetermined temperature), T2: Second temperature (Second predetermined temperature), and T3: Third temperature (third predetermined temperature)

1. A cooling system comprising:
a motor;
a power converter;
a flow path through which a cooling fluid flows to the motor and the power converter; and
a switching valve that switches the flow path through which the cooling fluid flows,
wherein
the flow path includes a first flow path and a second flow path that are bifurcated and rejoined,
the motor is disposed in the first flow path,
the power converter is disposed in the second flow path, and
the switching valve is disposed at a position where the flow path branches into the first flow path and the second flow path, and is configured to be switchable the flow path through which the cooling fluid flows to the first flow path and the second flow path.

2. The cooling system according to claim 1, further comprising a battery used to drive the motor, wherein
the switching valve switches the flow path through which the cooling fluid flows to the first flow path and the second flow path based on a temperature of the battery.

3. The cooling system according to claim 2, comprising a battery flow path connectable to the flow path in which the first flow path and the second flow path are joined, wherein
the battery is connected to the battery flow path.

4. The cooling system according to claim 3, wherein the switching valve switches the flow path through which the cooling fluid flows to the first flow path and the second flow path based on a temperature of the power converter.

5. The cooling system according to claim 4, wherein the switching valve is switched so as to allow the cooling fluid to flow only through the first flow path when a temperature of the battery is lower than or equal to a first predetermined temperature and a temperature of the power converter is lower than a second predetermined temperature, and the switching valve is switched so as to allow the cooling fluid to flow only through the second flow path when the temperature of the battery is lower or equal to than the first predetermined temperature and the temperature of the power converter exceeds a third predetermined temperature higher than the second predetermined temperature.

6. The cooling system according to claim 4, wherein the switching valve is switched so as to allow the cooling fluid to flow through both the first flow path and the second flow path when a temperature of the battery exceeds a first predetermined temperature.
